(19) United States
(12) Patent Application Publication
(10) Pub. No.: US 2025/0017231 A1
(43) Pub. Date: Jan. 16, 2025

(54) EASILY SPOONABLE PROTEIN-RICH SUPPLEMENT PASTE

(71) Applicant: Florida Research Group, LLC, Tampa, FL (US)

(72) Inventor: Kotha SEKHARAM, Tampa, FL (US)

(21) Appl. No.: 18/352,393

(22) Filed: Jul. 14, 2023

(51) Int. Cl. A23D 9/04; A23D 9/013; A23K 10/30; A23K 20/158; A23K 40/00; A23L 33/12

(52) U.S. Cl. CPC A23D 9/04; A23D 9/013; A23K 10/30; A23K 20/158; A23K 40/00; A23L 33/12

(57) ABSTRACT

This invention provides a protein-rich supplement composition and process of manufacturing such composition that is cleanly spoonable, cuttable, shapeable, spreadable, protein-rich and with reduced stickiness. In some embodiments, the process to manufacture such composition includes weighing, combining, and heating a nut butter, a shortening with a melting point not less than 104° F., a long chain fatty acid with 16 to 18 carbon atoms, a lecithin, and optionally, a health-promoting ingredient. The finished product has more than 15% protein content, and in a 45°-angle cut-through test, the knife path will not collapse even after 24 hours.

### BACKGROUND OF THE INVENTION

The importance of good nutrition and its benefits upon health and development are widely recognized. In addition to complementing one's diet to boost overall health and energy, nutritional supplements serve a variety of purposes including providing immune system support, improving performance in athletic and cognitive activities, reducing the risks of illness and age-related conditions, and supporting the recovery process from illness or injury. Nutritional supplements are normally available in solid dosage forms such as tablets, gummies, and soft chews, for ease of handling, portability, and convenience. However, these dosage forms may not be suitable or ill-favored by dysphagic users, i.e., users having swallowing problems such as certain geriatric users. While liquid may be a good alternative delivery form, it too suffers from drawbacks including: its consistency that is too runny to swallow for some dysphagic users; reduced portability compared to solid dosage forms; and difficulty in measuring and dosing as liquids often require measuring with a syringe, a measuring spoon, or a dropper, making it less convenient and even challenging to accurately dose, especially for certain users such as those having impaired motor skills. Liquid forms are often undesirable for owners of companion animals due to the same drawbacks. Accurate measurement of liquid forms can be particularly difficult while being interrupted by, for example, impatient dogs or children.

Similar problems arise with pharmaceuticals, wherein certain dosage forms may be inconvenient, difficult to swallow, handle, measure, or dose. Many pharmaceutical ingredients are also not palatable, causing non-adherence to treatment regimen by certain users, especially animals and children. Therefore, there is a need for an alternative delivery form for nutritional ingredients and pharmaceuticals.

Many users—humans and animals alike—love nut butters, in particular peanut butter, and hence they can be good carriers to deliver functional nutrients. However, some of the major hurdles of using nut butters as nutrient carriers are that they are sticky, clumsy, and difficult to dose, and feed. Some nut butters may have a consistency that is ideal for spreads but not for being swallowed by themselves. Additionally, many nut butters such as natural peanut butter are often beset with the problem of separation of oil. Due to these shortcomings of nut butters, it is not possible to obtain uniform distribution of nutritional or pharmaceutical ingredients within such medium or proper dosing. Moreover, some nut butters may require refrigeration and/or thorough mixing before use, which diminishes the portability and convenience of nutritional supplements and undermine their usefulness.

To the best of the inventor's knowledge, prior publications do not contemplate the suitability of a nut butter, particularly a peanut butter, as a carrier in nutritional supplements. Consequently, the teachings of prior publications are not catered to this purpose. For example, U.S. Pat. Nos. 3,671,267, 5,240,734, 6,703,064, 8,080,275, and 8,697,173 all concern with, to varying degrees, minimizing separation of peanut oil and particles in peanut butters as spreads. Some of these references also set out to improve the consistency and/or mouth feel of the resulting peanut butters, or to reduce the fat content of peanut butters as spreads. However, none of these references contemplate optimizing the characteristics of a peanut butter to render it better suited as a carrier for nutritional or pharmaceutical ingredients to be delivered to a user. Naturally, the references do not teach on improvements of relevant properties of nut-based products, e.g., spoonability, cuttability, shapeability, spreadability, ease of dosing, etc.

Most nutritional supplements that are known or available today are made with sugars, carbohydrates, and fibers, and hence carry limited amount of protein. One of the main reasons for this low protein content is that protein interferes with making tablets or chews. With increasing interest in health, users are always interested in maintaining a balanced nutrition, which creates a need for products with a reasonable protein content.

The inventor of the present invention has successfully discovered a protein-rich supplement composition and a process of making the composition that addresses the aforementioned problems associated with nut butters when attempting to use them as nutritional supplement carriers.

### BRIEF SUMMARY OF THE INVENTION

In one aspect, the present invention provides a protein-rich supplement composition in the form of a paste. In some embodiments, the composition is in the form of an orally consumable, nut butter-based paste comprising a health-promoting ingredient uniformly distributed within. A protein-rich supplement composition is palatable and easily dosed. More particularly, the protein-rich supplement composition according to the present invention is a nut butter-based formulation that is not only palatable and easily consumed, but also spoonable, cuttable, shapeable, spreadable, and rich in protein. In some embodiments, a nut butter used for the protein-rich supplement composition is a peanut butter.

In other aspects, the present invention is directed to the process of preparing a protein-rich supplement composition. In some embodiments, the process includes weighing, combining, and heating a nut butter, a shortening with a melting point not less than 104° F., a long chain fatty acid with 16 to 18 carbon atoms, a lecithin, and optionally, a health-promoting ingredient. In some embodiments, the finished product has more than 15% protein content, and is cleanly spoonable, cleanly cuttable, spreadable, shapeable, and stable. Surprisingly, in a 45°-angle cut-through test, a knife path in the composition does not collapse even after 24 hours.

### DETAILED DESCRIPTION OF THE INVENTION

The present invention provides a protein-rich supplement composition, as well as methods of preparing same. In one aspect, the invention is particularly suitable as an alternative form to solid or liquid dosage forms for delivering health-promoting ingredients to a subject. In some aspects, the present invention may be a convenient treat given the ease of handling and its high protein content.

In one aspect, a protein-rich supplement composition according to the present invention is in the form of a paste. A paste as used herein has a meaning as understood by a person skilled in the art, i.e., a semi-liquid colloidal suspension, emulsion, or aggregation used in preparation of a final consumable product or consumed by itself.

In some embodiments, the protein-rich supplement composition is an orally administered, nut-based paste, possessing characteristics providing superior advantages over conventional/natural nut butters or nut butter-based products to deliver health-promoting ingredients of choice. For example, the protein-rich supplement composition according to the present invention is less sticky than conventional/natural nut butters, surprisingly spreadable, spoonable, yet shapable and cuttable with a table knife. The protein-rich supplement composition is also stable such that it is free from phase separation. These advantageous characteristics allow a health-promoting ingredient of choice to be uniformly incorporated within the composition, easily dosed and delivered to a subject. Additionally, a protein-rich supplement composition is palatable and rich in protein, comprising not less than 15% of protein by weight relative to the final composition.

In certain embodiments, the protein-rich supplement composition according to the present invention is spoonable. “Spoonable,” “Spoonability,” and variations thereof as used herein refer to a composition that at room temperature is readily scoopable with a conventional spoon to obtain and deliver a spoonful of the composition at a time. Preferably, the protein-rich supplement composition is “cleanly” spoonable, which indicates that the composition can be scooped with a spoon with essentially no composition being visible on parts of the spoon other than the bowl, such as the back or neck of the spoon. Due to their inherent sticky property, nut butters generally are not cleanly spoonable. This is especially true with conventional or natural peanut butters, as they tend to stick to virtually any surface of a utensil that comes in contact. Spoonability of a composition is particularly important for dosing.

In further embodiments, the protein-rich supplement composition according to the present invention is cuttable. As used herein, “cuttable,” “cuttability” and variations thereof refer to a composition that at room temperature can be divided into two distinct pieces by a cut of a knife or a similar utensil. Preferably, the protein-rich supplement composition is “cleanly” cuttable, meaning the composition can be cut with essentially no composition being left visible on the utensil that is used to cut it. This is not possible with conventional or natural peanut butters because of their soft and sticky consistency.

In further embodiments, the protein-rich supplement composition according to the present invention is shapeable. As used herein, “shapeable,” “shapeability” or variations thereof refer to the ability of a composition to be molded into a shape and to substantially retain the shape at room temperature until disturbed for at least 1 hour, preferably 12 hours, and more preferably 24 to 48 hours. This is not possible with conventional or natural peanut butters as they soften and lose their shape after a while at room temperature.

In further embodiments, the protein-rich supplement composition according to the present invention is spreadable. “Spreadable,” “spreadability,” and variations thereof have a standard meaning as understood by persons skilled in the art. In some embodiments, the degree of spreadability is evaluated by a method in accordance with Grading Manual for Peanut Butter recommended by the United States Department of Agriculture (USDA), effective April 2011 (available at: www.ams.usda.gov/sites/default/files/media/Peanut_Butter_Inspection_Instructions % 5B1% 5 D.pdf). In some embodiments, the composition to be evaluated should be naturally cooled and left undisturbed until its internal temperature reaches between 70° F. and 80° F. (21° C. and 27° C.). Preferably, the protein-rich supplement composition according to the present invention has the spreadability equivalent to the consistency for U.S. Grade A peanut butter, i.e., “it spreads easily on fresh bread (having a moderately dense crumb) without appreciable tearing or breaking of the bread.”

In further embodiments, the protein-rich supplement composition according to the present invention is stable, meaning that visible separation of oil from the composition does not occur after storage at room temperature. In some embodiments, the stability of a protein-rich supplement composition is evaluated by a method in accordance with the USDA's Grading Manual for Peanut Butter. In some embodiments, the composition has no free oil observed on its surface after storage in a container for at least 24 hours, more preferably at least 48 hours after it has been packaged. In other embodiments, the composition has no free oil observed on its surface after storage in a container for at least 30 days, preferably at least 60 days or more after it has been packaged.

In some embodiments, because of its advantageous characteristics, a protein-rich supplement composition according to the present invention is surprisingly capable of retaining a knife path for at least 12 hours, preferably for at least 24 hours at room temperature after a knife is inserted through the composition at an approximately 45° angle. In some embodiments, a method of testing for this knife path retention is in accordance with the USDA's Grading Manual for Peanut Butter.

These advantageous characteristics of the protein-rich supplement composition allow a health-promoting ingredient of choice to be uniformly incorporated within the composition and conveniently delivered to a subject. The terms “uniform,” “uniformly,” and variations thereof as used herein with respect to the distribution of an ingredient in a composition suggests that a spoonful of the composition contains approximately the same amount of the ingredient as any other spoonful of the same composition. Because a protein-rich supplement composition uniformly incorporates within itself a health-promoting ingredient and a predetermined amount of the composition is obtainable (e.g., in spoonfuls) without using complicated tools, the nutritional supplement is easily and conveniently dosed.

A protein-rich supplement composition according to the present invention is an orally consumable composition. Orally consumable products according to the invention are any preparations or compositions suitable for consumption by a subject, and are intended to be introduced into the human or animal oral cavity, to remain there for a certain period of time and consumed. A health-promoting ingredient in an orally consumable composition is delivered via initial absorption into the gastrointestinal tract, or into the mucus membranes of the mouth.

A protein-rich supplement composition according to the invention is palatable and easy to swallow such that it can be consumed by itself. Thus, the composition by itself can be a ready-to-serve, spoonable product that is easily dosed. Consumption of the composition is effortless due to its advantageous properties. However, it is also contemplated that the composition according to the present invention is further processed and/or mixed with additional ingredients so that it forms a component of a formulation or a food item intended to be consumed for nutrition or pleasure. This depends on the type and form of a health-promoting ingredient to be delivered and the intended subject. The present compositions may be provided as semi-finished products to be used for the production of other compositions intended for nutrition or pleasure.

As non-limiting examples, the protein-rich supplement composition may be a component of solid dosage forms such as tablets, gummies, and soft chews. As additional non-limiting examples, the protein-rich supplement composition may form a component of, mixed with, or otherwise associated with baked products (e.g., bread, dry biscuits, cookies, cake, and other pastries), sweets (e.g., chocolates, chocolate bar products, other bar products, fruit gum, coated tablets, hard caramels, toffees and caramels, and chewing gum), beverages (e.g., cocoa, coffee, tea), instant beverages (e.g., instant cocoa beverages, instant tea beverages, and instant coffee beverages), meat products (e.g., ham, fresh sausage preparations or raw sausage preparations, marinated fresh meat or salted meat products), eggs or egg products (e.g., dried whole egg, egg white, and egg yolk), cereal products (e.g., breakfast cereals, muesli bars, and pre-cooked instant rice products), dairy products (e.g., whole fat or fat reduced or fat-free milk beverages, rice pudding, yoghurt, kefir, cream cheese, soft cheese, hard cheese, dried milk powder, whey, butter, buttermilk, and partly or wholly hydrolyzed products containing milk proteins), products from soy protein or other soy bean fractions (e.g., soy milk and products prepared thereof, beverages containing isolated or enzymatically treated soy protein, soy flour containing beverages, preparations containing soy lecithin, fermented products such as tofu or tempeh products prepared thereof and mixtures with fruit preparations and, optionally, flavoring substances), products on the basis of fat and oil or emulsions thereof (e.g., mayonnaise, remoulade, and dressings), dips for various food items (such as dips for apples, bananas, celeries, chips, crackers), etc.

As a further non-limiting example, the protein-rich supplement composition is suitable as a stable, non-dripping center fill in harder, coextruded edible objects such as dental sticks or similar treats for companion animals. In other non-limiting examples, the protein-rich supplement composition is also suitable as a stable, non-dripping fill in shaped toys for companion animals, such as shaped dog toys.

In some embodiments, a protein-rich supplement composition according to the present invention serves as stable center fill of a solid crunchy material without affecting the crunchiness of the material, providing contrasting soft texture and nutrition to a subject consuming it. To the best of the inventor's knowledge, such center fill has been hitherto not available.

These and other features and advantages of the present invention will become more apparent to those skilled in the art from the detailed description of embodiments provided herein.

### Components of a Protein-Rich Supplement Composition

In one aspect, the present invention provides a protein-rich supplement composition comprising a nut butter, a long chain fatty acid, a shortening, a lecithin. In further embodiments, the composition comprises no other ingredient, or the composition comprises at least one additional ingredient but it does not materially affect the superior characteristics of the composition.

In other embodiments, a protein-rich supplement composition comprises a nut butter, a long chain fatty acid, a shortening, a lecithin, and a health-promoting ingredient that is uniformly distributed within the composition. In further embodiments, the composition comprises no other ingredient, or the composition comprises at least one additional ingredient but it does not materially affect the superior characteristics of the composition.

In specific embodiments, the present composition provides a protein-rich supplement composition comprising from about 50% to about 90% nut butter, about 0.1% to about 5% long chain fatty acid, about 1% to about 15% shortening, about 0.5% to about 4.5% lecithin, and 0% to about 25% one or more health-promoting ingredient.

### Nut Butter

In one aspect, a protein-rich supplement composition of the present invention comprises a nut butter. The term “nut butter” or “butter” as used herein shall be defined to include spreadable food products made from grinding or similarly processing nuts, legumes, seeds, fruits, and the like. Nut butters useful in the present invention include those butters made from nuts or ground nuts or seeds, including peanuts, almond, hazelnut, walnut, pistachio, cashew, pecan, macadamia nut, sunflower seeds, soy seeds, and sesame seeds. The nut butter component may comprise mashed, macerated, ground or otherwise crushed nuts alone, or in combination with other common nut butter ingredients, such as sweeteners and stabilizers. The nut butter component may comprise a nut butter from a single nut type, or nut butters from several nut types. Commercially available traditional peanut butter may also be used. In such case, peanut butter is made with, for example, peanuts, dextrose, hydrogenated vegetable oil (rapeseed oil and cottonseed and/or soybean oil) and salt. In some embodiments, a nut butter according to the present invention has a melting point of not less than 110° F. If more than one type of nut butter is used in a protein-rich supplement composition, the melting point of the mixture should be not less than 110° F.

In some embodiments, a protein-rich supplement composition according to the present invention comprises from about 50% to about 90%, more preferably from about 70% to about 85% of one or more nut butter. In specific embodiments, the protein-rich supplement composition comprises from about 80% to about 85% of one or more nut butter. In more specific embodiments, the protein-rich supplement composition comprises about 85% of one or more nut butter. In some embodiments, a nut butter according to the present invention comprises a peanut butter. In other embodiments, a nut butter according to the present invention consists of a peanut butter.

### Long-Chain Fatty Acid

In further aspects, a protein-rich supplement composition of the present invention comprises one or more long-chain fatty acid, an ester thereof, or a salt thereof. Long-chain fatty acids generally are saturated or unsaturated fatty acids containing 13 to 24 carbons. These fatty acids are amphiphilic, being quite polar (hydrophilic) at their carboxyl end and quite nonpolar (hydrophobic) at the methyl end. Preferably, the fatty acids used in the present invention are GRAS (generally recognized as safe) ingredients or otherwise known to be safe for consumption by the intended subject.

In some embodiments, a long-chain fatty acid useful in the present invention has carbon atoms between 16 and 18 in its chain with or without an unsaturation. In some embodiments, a long-chain fatty acid useful in the present invention has carbon atoms between 16 and 24 in its chain with or without an unsaturation. In other embodiments, a long-chain fatty acid useful in the present invention has carbon atoms between 18 and 24 in its chain with or without an unsaturation. Non-limiting examples of the long-chain fatty acid according to the present invention include palmitic acid (16 carbon atoms), stearic acid (18 carbon atoms). In some embodiments, the protein-rich supplement composition of the present invention comprises a long chain fatty acid that is palmitic acid, stearic acid, or a combination thereof.

Palmitic acid is the most common saturated fatty acid in plant lipids and animal lipids (in fish oils, in the milk and storage fat of many mammals).

Stearic acid is found in various animal and plant fats, and is a major component of cocoa butter and shea butter. Unlike other long-chain saturated fatty acids, stearic acid has no effect on lipoprotein cholesterol concentrations in men or women.

In some embodiments, long-chain fatty acids according to the invention may be in the form of a salt an ester thereof. The salt or ester of a long-chain fatty acid may be included in a protein-rich supplement composition in lieu of, or in addition to, the same or a different long-chain fatty acid. In specific embodiments, a salt or an ester of stearic acid called stearates may be included in the protein-rich supplement composition. Preferably, salts and esters of long-chain fatty acids are GRAS or otherwise known to be safe for consumption by the intended subject. Non-limiting examples of salts of long-chain fatty acids that may be useful in the present invention include calcium stearate, lithium stearate, magnesium stearate, sodium stearate, and zinc stearate. Non-limiting examples of esters of long-chain fatty acids that may be useful in the present invention include glycol stearate and stearin.

In some embodiments, a protein-rich supplement composition according to the present invention comprises from about 0.1% to about 5.0%, preferably from about 0.5% to about 1.5%, of one or more fatty acid. In specific embodiments, a fatty acid comprises stearic acid. In other embodiments, a fatty acid according to the present invention consists of stearic acid.

### Shortening

In further aspects, a protein-rich supplement composition of the present invention comprises one or more shortening. Shortening is any fat of vegetable or animal source that is solid or semi-solid at room temperature. It is named for the “short” or crumbly texture that it produces in cooking and baking applications, particularly in shortbread, piecrusts and puff pastry. A shortening may be made from non-hydrogenated, hydrogenated, or partially hydrogenated oils. Preferably, a shortening used in the present invention has a melting point of not less than 104° F. If more than one type of shortening is used, the melting point of the mixture of shortenings is preferably not less than 104° F.

According to the present invention, the source of a shortening may be vegetable or animal. In some embodiments, a shortening used in the present invention comprises a vegetable shortening. In other embodiments, a shortening used in the present invention consists of a vegetable shortening. Vegetable shortening is a semisolid fat that is mostly solid at room temperature. Vegetable shortening inhibits the formation of long, tough strands of gluten in dough and contributes a light texture. Vegetable shortening is typically made from hydrogenated and partially hydrogenated vegetable oils, such as corn, cottonseed or soybean. It has a higher smoke point than butter and margarine, and is 100% fat (compared to butter and margarine that contain milk solids).

In further embodiments, a shortening used in the present invention comprises an animal fat such as beef fat or butter. In further embodiments, a shortening used in the present invention consists of an animal fat. In some embodiments, a shortening used in the present invention is a combination of a vegetable oil and an animal fat.

In some embodiments, a protein-rich supplement composition according to the present invention comprises from about 1% to about 15%, preferably from about 10% to about 15% of one or more shortening. In some embodiments, a shortening used in the present invention comprises a vegetable shortening that is non-hydrogenated, partially hydrogenated, or hydrogenated, preferably at least partially hydrogenated. In other embodiments, a shortening used in the present invention consists of a vegetable shortening that is non-hydrogenated, partially hydrogenated, or hydrogenated, preferably at least partially hydrogenated.

### Lecithin

In further aspects, the protein-rich supplement composition of the present invention comprises one or more lecithin. Lecithin is prepared by extraction and purification from naturally occurring products such as soybeans, eggs, and sunflower and canola seeds. Lecithin is a multi-purpose food ingredient that primarily functions as an emulsifier and dispersing agent. Lecithin is also a surfactant. Lecithin's surface-active property can be attributed to its chemical composition which is a complex mixture of phospholipids, glycolipids, carbohydrates and triglycerides. The phospholipids in lecithin generally comprise phosphatidylcholine, phosphatidylethanolamine, phosphatidylinositol, phosphatidylserine, and phosphatidic acid. As such, lecithin interacts well with other substances in foods, such as proteins, lipids and carbohydrates.

Lecithin according to the present invention can be fluid lecithin, de-oiled lecithin, and/or fractionated lecithin. In some embodiments, lecithin used in the protein-rich supplement composition of the present invention comprises a fluid lecithin. Fluid lecithin is a blend of phospholipids and vegetable oils.

In some embodiments, lecithin used in the protein-rich supplement composition of the present invention comprises a de-oiled lecithin. Unlike fluid lecithin, de-oiled lecithin is free of residual vegetable oil, providing more concentrated phospholipids for enhanced dispersion in water for easier handling, as de-oiled lecithin is easily soluble in oil or fat. Neutral in both color and flavor, its improved functionality makes it a popular choice for a wide range of bakery, beverage, snack, and instantizing applications.

In some embodiments, lecithin used in the protein-rich supplement composition of the present invention comprises a fractionated lecithin Fractionated lecithin offers increased concentrations of phosphatidylcholine (PC) or acidic phospholipids. Used primarily in dietary supplements as well as pharmaceutical and personal care applications, fractionated lecithin provides increased water dispersibility, enhanced emulsification, and suspension properties, and can serve as an anti-crystallization agent.

In some embodiments, lecithin used in the present invention is one of fluid lecithin, de-oiled lecithin, and fractionated lecithin. In other embodiments, lecithin used in the present invention is any combination of fluid lecithin, de-oiled lecithin, and fractionated lecithin. In some embodiments, a lecithin used according to the present invention comprises a fluid lecithin from vegetable oil. In other embodiments, a lecithin used according to the present invention consists of a fluid lecithin from vegetable oil. In some embodiments, a protein-rich supplement composition according to the present invention comprises from about 0.5% to about 4.5%, preferably from about 0.5% to about 2% of one or more lecithin.

### Health-Promoting Ingredients

In further aspects, a protein-rich supplement composition of the present invention comprises one or more health-promoting ingredient as an optional component. A health-promoting ingredient according to the present invention is an added component in addition to what is inherently present in other components present in the protein-rich supplement composition. Thus, in some embodiments, the protein-rich supplement composition of the present invention comprises no health-promoting ingredient. In other embodiments, the protein-rich supplement composition of the present invention comprises at least one health-promoting ingredient. In further embodiments, the health-promoting ingredient is uniformly distributed within the protein-rich supplement composition.

According to the present invention, various health-promoting ingredient of choice may be included in the protein-rich supplement composition. In some embodiments, a health-promoting ingredient is a nutritional ingredient, for example, vitamin, mineral, amino acid, protein, herb, extract (e.g., plant extract), probiotic, omega oil, fiber, and the like. In some embodiments, a nutritional ingredient may contain such active nutritional component with one or more additional inactive component such as fillers, flavoring agents, preservatives, coloring agents, etc.

In further embodiments, a health-promoting ingredient may be a pharmaceutical. In some embodiments, a pharmaceutical according to the present invention refers to an active pharmaceutical ingredient (API). An API according to the present invention may be a component of an over-the-counter (OTC) or prescription medication that causes the intended health effects. In some embodiments, a pharmaceutical according to the present invention refers to an API as an active component as well as an inactive component such as excipients. In certain embodiments, a pharmaceutical according to the present invention is intended for oral administration, and can be in various forms including, but are not limited to, powders, liquids, and emulsions.

Further non-limiting examples of health-promoting ingredients include any category of nutritional ingredient and/or pharmaceutical used for purposes including: relieving pain, fever and/or inflammation; reducing the symptoms of allergies or colds; suppressing or treating a virus; treating cancer; treating a microbial infection; suppressing or preventing seizures; lowering or managing cholesterol; lowering or managing blood pressure; managing diabetes; treating depression or anxiety; controlling body weight; and reducing or enhancing hormone levels.

In some embodiments, a protein-rich supplement composition according to the present invention comprises from 0% to about 25% of one or more health-promoting ingredient. In some embodiments, a health-promoting ingredient according to the present invention is a nutritional ingredient, a pharmaceutical, or any combination thereof. In further embodiments, the percentage of a health-promoting ingredient reflects only the amount of the active component in the health-promoting supplement composition. In other embodiments, the percentage of a health-promoting ingredient reflects the amount of the active and inactive components of the health-promoting ingredient. In further embodiments, a health-promoting ingredient according to the present invention is stable within the range of temperatures in which a protein-rich supplement composition is manufactured.

### Protein-Rich Content

In further aspects, a protein-rich supplement composition of the present invention is rich in protein such that it has a protein content not less than 15% by weight of the protein-rich supplement composition. In certain embodiments, the protein content of a protein-rich supplement composition is at least about 15%, 20%, 25%, 30%, 35%, 40%, 45%, or 50% by weight of the composition. In some embodiments, the protein content of a protein-rich supplement composition may refer to the protein content in the nut butter present in the composition when no other component in the composition can be a source of protein. In other embodiments where a health-promoting ingredient includes a protein, the protein content of a protein-rich supplement composition refers to the total protein content of the protein-rich supplement composition, including the protein in the nut butter as well as the health-promoting ingredient present in the composition.

The protein content of a protein-rich supplement composition may be determined by a method known in the art. Some methods for measuring protein content in foods include, but are not limited to, the Kjeldahl method, Dumas method, direct measurement methods using UV-spectroscopy and refractive index measurement. In some embodiments of the present invention, the Kjeldahl method is used. The Kjeldahl method involves the digestion of food with a strong acid so that nitrogen is released, which is then quantified using a titration technique. Protein quantity is calculated from the nitrogen concentration of the food using a conversion factor (e.g., 6.25).

In other embodiments of the present invention, a method other than the Kjeldahl method is used to measure the amount of protein in a protein-rich supplement composition. For example, the Dumas method is considered an alternative to the classical Kjeldahl method, and involves combustion of a sample of known mass at high temperature in an oxygen atmosphere. The resulting gases are passed over columns to separate and quantify the nitrogen content. UV spectrophotometric methods, including the Biuret. Bradford and Lowry methods, measure sample absorption at specific wavelengths. Direct amino acid analysis involves hydrolysis of the protein with HCL and subsequent quantification of the amino acids using HPLC.

### Optional Excipients

In some embodiments, a protein-rich supplement composition optionally comprises one or more excipients that are known in the art to be suitable for human or animal consumption, depending on the intended subject. Non-limiting examples of excipients include permissible colors, flavors, fillers, textured objects, or a combination thereof. Manufacturing process

In other aspects, the present invention provides a method of preparing a protein-rich supplement composition. In general embodiments, the method comprises the steps of: weighing and blending effective amounts of a shortening, a long chain fatty acid with 13 to 24 carbon atoms, preferably 16 to 18 carbon atoms, in its chain, and a lecithin to form a first blend; heating the first blend to about the melting point of the long chain fatty acid but not more than about 157° F.; combining the first blend with a nut butter to form a second blend; heating the second blend to about the melting point of the long chain fatty acid but not more than about 157° F.; optionally adding to the heated second blend an effective amount of a health-promoting ingredient to form a third blend and blending to uniformity; and cooling the third blend at room temperature to form the protein-rich supplement composition. Optionally, the third blend may be filled into a final packaging prior to cooling.

In preferred embodiments, a method of preparing a protein-rich supplement composition comprises the steps of: weighing and blending from about 10% to about 15% of a vegetable shortening, from about 0.5% to about 1.5% of stearic acid, from about 0.5 to about 2% of a lecithin to form a first blend; heating the first blend to about 157° F., combining the first blend with from about 80% to about 85% of a peanut butter to form a second blend, heating the second blend to about 157° F.; optionally adding to the heated second blend an effective amount of a health-promoting ingredient to form a third blend; mixing the third blend to uniformity; and cooling the third blend at room temperature to form the protein-rich supplement composition. Optionally, the third blend may be filled into a final packaging prior to cooling.

The protein-rich supplement composition prepared according to the methods of the present invention is advantageously stable, spoonable, cuttable, shapeable, spreadable, and palatable. Furthermore, the protein-rich supplement composition is versatile such that it is capable of uniformly incorporating various health-promoting ingredient of choice. Because of these advantageous properties of the composition, the health-promoting ingredient formulated in the composition is easily dosed. Furthermore, the composition is advantageously rich in protein content.

The general scheme of the manufacturing process is an important aspect of the present invention to obtain a protein-rich supplement composition having the advantageous characteristics as discussed herein. Heating and blending at specified temperatures and order surprisingly affects the outcome of the finished product. Furthermore, overheating of the blends during the manufacturing process causes damage to the protein-rich supplement composition due to oxidation.

### EXAMPLES

Following are Examples which are offered by way of illustration and are not intended to limit the invention. Unless otherwise stated, these Examples utilized the methods, techniques, and materials known in the art. Various modifications or changes in light thereof will be suggested to persons skilled in the art and are to be included within the spirit and purview of this application.

### Example 1: Preparation of a Probiotic Supplement

Into a scraped surface heating kettle, from about 10% to about 15% of a vegetable shortening, from about 0.5% to about 1.5% of stearic acid flakes, and from about 0.5% to about 2% of a lecithin were weighed and added. The mixture was heated to a temperature not exceeding about 157° F.

While stirring the contents of the kettle, about 85% of a peanut butter was weighed and added to the kettle. The temperature of about 157° F. was maintained.

0.18% of heat-stable Bacillus coagulans providing 1 billion colony-forming units per 3 gram dose was added to the kettle and blended to uniformity. The resulting protein-rich supplement composition in the form of a paste was filled into a final package and set to cool at room temperature to obtain a probiotic supplement.

### Example 2: Preparation of a Probiotic Supplement Center Fill for Dental Sticks

Into a scraped surface heating kettle, from about 10% to about 15% of a vegetable shortening, from about 0.5% to about 1.5% of stearic acid flakes, and from about 0.5% to about 2% of a lecithin were weighed and added. The mixture was heated to a temperature not exceeding about 157° F.

While stirring the contents of the kettle, about 85% of a peanut butter was weighed and added to the kettle. The temperature of about 157° F. was maintained.

0.09% of heat-stable Bacillus coagulans providing 1 billion colony-forming units per 6 gram dental stick dose was added to the kettle and blended to uniformity. The resulting a protein-rich supplement composition was ready for use as a center fill in hollow dental sticks.

Dental sticks for dogs were prepared by loading a composition containing 57 parts of corn starch, 7 parts of wheat flour, 7 parts of pork liver powder, 25 parts of water and 7 parts of glycerin into a single head extruder, wherein the composition was cooked and extruded through a die to form a hollow rope, wherein the second extruder filled the soft center fill composition prepared above into the hollow rope. The shaped, filled rope was cooled in a cooling tunnel and cut to desired length to form crunchy dental sticks having a soft probiotic supplement center fill. The center fill is stable, hard enough to stay in place, and soft enough to create a contrasting bite to the outer layer of the dental sticks.

### Example 3: Preparation of a Protein-Rich Supplement for Pediatric Eye Care

Into a scraped surface heating kettle, from about 10% to about 15% of a vegetable shortening, from about 0.5% to about 1.5% of stearic acid flakes, and from about 0.5% to about 2% of a lecithin were weighed and added. The mixture was heated to a temperature not exceeding about 157° F.

While stirring the contents of the kettle, about 85% of a peanut butter was weighed and added to the kettle. The temperature of about 157° F. was maintained.

Astaxanthin oil at 0.30% level and Marigold extract containing lutein and Zeaxanthin at 0.78% were added to the kettle and blended to uniformity and cooled. The resulting protein-rich supplement composition in the form of a paste was filled into a final package and set to cool at room temperature to obtain the final supplement.

### Example 4: Preparation of a Protein-Rich Supplement for Autism Spectrum Disorder (ASD)

Into a scraped surface heating kettle, from about 10% to about 15% of a vegetable shortening, from about 0.5% to about 1.5% of stearic acid flakes, and from about 0.5% to about 2% of a lecithin were weighed and added. The mixture was heated to a temperature not exceeding about 157° F.

While stirring the contents of the kettle, about 85% of a peanut butter was weighed and added to the kettle. The temperature of about 157° F. was maintained.

Palmitoylethanolamide at 5% level was added to the kettle and blended to uniformity and cooled. The resulting protein-rich supplement composition in the form of a paste was filled into a final package and set to cool at room temperature to obtain the final supplement.

### Example 5: Testing of the Probiotic Supplement

The finished probiotic supplement products prepared according to Examples 1 and 2 were tested for one or more of the following characteristics:

Evaluation of consistency. Consistency in this Example was demonstrated by the evaluation of the stability, spreadability, ability to retain a knife path, and spoonability of the product. Tests for the stability, spreadability, and ability to retain a knife path were conducted consistent with the USDA's Grading Manual for Peanut Butter.

Before the product samples of Example 1 were evaluated, they were undisturbed after packaging and palletizing, and until the internal temperature reached between 70° F. and 80° F. The product samples were allowed to naturally cool to 70° F. to 80° F., and not cooled artificially (e.g., in a cooler or water bath).

After at least 48 hours has passed after packaging, the product samples were opened, and the surface was carefully checked for the presence of any free oil. No oil was observed demonstrating its stability.

The product sample was tested for ease of spread on fresh bread (having a moderately dense crumb) without appreciable tearing or breaking of the bread. Test product sample passed this test.

To evaluate the ability of the product to retain a knife path, portions of the product samples were removed from the container. A table knife was inserted approximately 2½ inches into the product sample at a 45° angle cut. The pass/fail threshold was set such that if the product developed a gelatin-like condition that is more than slightly noticeable, or if the knife path collapsed within about 3 seconds, the product would be deemed a failure. In this test, the product did not develop a gelatin-like consistency, and surprisingly, the knife path did not collapse even after 24 hours, indicating the successful result of the product and the present invention.

To evaluate spoonability, the product was spooned out with a small spoon and fed to dogs. The product used in this Example was designed to have a dose of 3 grams, which is the size of an average grape. A designated amount of the product was able to be spooned out cleanly without any stickiness, and consumed effortlessly by 12 dogs.

Evaluation of palatability. A sample of each of the product prepared according to Examples 1 and 2 was tested for palatability to 12 dogs. The results indicated 100% palatability for all 12 dogs tested at the kennel.

Evaluation of protein content. The protein content of the product of Example 1 was evaluated and found to be more than 15% of the finished weight.

The above results indicate usefulness of the present invention.

Unless specifically stated or obvious from context, all references to ingredient percentages are to the weight percentage (w/w) as part of the protein-rich supplement composition as a final product.

The term “subject” or “patient,” as used herein, describes an organism, including mammals such as primates. Mammalian species that can benefit from the disclosed methods of treatment include, but are not limited to, apes, chimpanzees, orangutans, humans, and monkeys; domesticated animals such as dogs, cats; live stocks such as horses, cattle, pigs, sheep, goats, and chickens; and other animals such as mice, rats, guinea pigs, and hamsters. The term “subject” or “patient,” as used herein, may encompass companion animals such as dogs, cats, horses, rabbits, ferrets, birds, guinea pigs and select other small mammals, small reptiles, and fish.

As used herein, the term “effective amount” is used to refer to an amount of something (e.g., a compound, a composition, time) that is capable of causing a desired outcome (e.g., improvement in the consistency of the final composition). The terms “effective amount,” and “effective dose” as applied to a health-promoting ingredient according to the present invention may refer to, depending on the health-promoting ingredient being provided, a therapeutically effective amount or a predetermined amount that is intended to be incorporated into a protein-rich supplement composition that contributes to the well-being of a subject.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention, e.g., the ability to improve the bioavailability of a substance. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “an” and “the” are understood to be singular or plural.

Unless specifically stated or obvious from context, as used herein, the term “about” is understood as within a range of normal tolerance in the art, for example, within 2 standard deviations of the mean. As further examples, “about” can be understood as within 10%, 9%, 8%, 7%, 6%, 5%, 4%, 3%, 2%, 1%, 0.5%, 0.1%, 0.05%, or 0.01% of the stated value.

When ranges are used herein, such as for dose ranges, combinations and sub-combinations of ranges (e.g., subranges within the disclosed range), specific embodiments therein are intended to be explicitly included.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

Any compositions or methods provided herein can be combined with one or more of any of the other compositions and methods provided herein.

1. A process of manufacturing a protein-rich supplement composition comprising the following steps, which are performed sequentially:
i) blending a shortening, stearic acid and, optionally one or more additional long chain fatty acids having 13 to 24 carbon atoms in its chain, and a lecithin to form a first blend;
ii) heating the first blend to within 3% of the melting point of stearic acid but not exceeding 157° F.;
iii) combining the first blend with a nut butter to form a second blend;
iv) heating the second blend to within 3% of the melting point of stearic acid but not exceeding 157° F.;
v) adding a health-promoting ingredient to form a third blend and blending to uniformity; and
vi) cooling the third blend at room temperature to obtain said protein-rich supplement composition;
wherein said protein-rich supplement composition comprises 50% to 90% w/w of said nut butter, and 0.1% to 5.0% w/w of stearic acid; and
wherein said protein-rich supplement composition is cleanly spoonable, cleanly cuttable, spreadable, shapeable, and stable.

2. The process according to claim 1, wherein said shortening has a melting point not less than 104° F.

3. The process according to claim 1, wherein said shortening is made from vegetable oil, animal fats, or a combination thereof.

4. The process according to claim 1, wherein said protein-rich supplement composition comprises 1% to 15% w/w of said shortening.

5. The process according to claim 1, wherein said long chain fatty acid comprises palmitic acid, stearic acid, or a combination thereof.

6-8. (canceled)

9. The process according to claim 1, wherein said protein-rich supplement composition comprises 0.5% to 4.5% w/w of said lecithin.

10. The process according to claim 1, wherein said nut butter comprises butter made from peanuts, almond, hazelnut, walnut, pistachio, cashew, pecan, macadamia nut, or a combination thereof.

11. The process according to claim 1, wherein said nut butter has a melting point not less than 110° F.

12. The process according to claim 1, wherein said nut butter comprises peanut butter.

13. (canceled)

14. The process according to claim 1, comprising adding a health-promoting ingredient selected from vitamins, probiotics, plant extract, pain relievers, anti-inflammatory compounds, anti-viral compounds, anti-cancer compounds, antimicrobials, and anti-anxiety compounds.

15. (canceled)

16. The process according to claim 1, wherein said protein-rich supplement composition is a center fill in a coextruded edible object.

17-19. (canceled)

20. A protein-rich supplement composition comprising:
a shortening;
a long chain fatty acid having 13 to 24 carbon atoms in its chain;
a lecithin;
a nut butter;
a health-promoting ingredient,
wherein said protein-rich supplement composition is cleanly spoonable, cleanly cuttable, spreadable, shapeable, and stable, and wherein the composition comprises:
1% to 15% w/w of said shortening;
0.1% to 5.0% w/w of said long chain fatty acid having 13 to 24 carbon atoms in its chain;
0.5% to 4.5% w/w of said lecithin;
50% to 90% w/w of said nut butter; and
a health-promoting ingredient selected from vitamins, probiotics, plant extract, pain relievers, anti-inflammatory compounds, anti-viral compounds, anti-cancer compounds, antimicrobials, and anti-anxiety compounds.

21-22. (canceled)

23. The composition according to claim 20, wherein said long chain fatty acid comprises palmitic acid, stearic acid, or a combination thereof.

24. The composition according to claim 20, comprising a probiotic.

25. The composition according to claim 20, comprising a plant extract.

26. The process according to claim 14, comprising adding a probiotic as a health-promoting ingredient.

27. The process according to claim 14, comprising adding a plant extract as a health-promoting ingredient.

28. A shaped toy for a companion animal wherein said toy comprises a composition of claim 20 as a filling.
